(19) United States
(12) Patent Application Publication
(10) Pub. No.: US 2005/0092709 A1
(43) Pub. Date: May 5, 2005

(54) Microprobe for testing electronic device and manufacturing method thereof

(75) Inventors: Kuk Jin Chun, Seoul (KR); Bong Hwan Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Seoul National University Industry Foundation

(21) Appl. No.: 10/674,576

(22) Filed: Sep. 30, 2003

(30) Foreign Application Priority Data
Mar. 24, 2003 (KR) 10-2003-0018296

(51) Int. Cl. H01B 13/00

(52) U.S. Cl. 216/13

(57) ABSTRACT

A microprobe is manufactured by forming via hole on one edge portion of the silicon substrate, filling the via hole with the conductive layer, forming the conductive spring unit on the silicon substrate so as to be electrically connected to the conductive layer in the via hole, forming the conductive tip portion on the leading end of the spring unit, removing the silicon substrate under the spring unit using isotropic etching, thereby supporting the spring unit only on the portion adjacent to the via hole. The spring unit and the tip portion are formed only in the window of a PR. The microprobe has benefits in that a separation of signal between tip portions is easy and mechanical and electrical properties of the probe tip are good, since the probe is formed on the silicon substrate by using micro-processing. Also, since the pitch between the tip portions can be reduced, a semiconductor device with fine pitch pad can be tested. Furthermore, the uniformity of flatness of the probe tip portion can be improved.

### BACKGROUND OF THE INVENTION

1. Field of the Invention

The present invention relates to a microprobe for testing electrical characteristics of semiconductor devices, and more particularly to a microprobe for testing electrical characteristics of semiconductor devices and a manufacturing method thereof which reduces pitch of a probe tip and improves a flatness and a uniformity by forming a cantilever type probe on a silicon substrate using MicroElectroMechanical Systems (MEMS).

2. Description of the Related Art

In a manufacturing process for semiconductor Integrated Circuit (IC) devices such as memory devices, non-memory devices or logic devices, after chips are fabricated on a wafer such as a silicon substrate, the wafer is tested to determine if an individual chip is good or defective before the chips of the wafer are cut into separate chips. The test is generally performed in a state that a probe card is connected to a probe device and a probe needle of the probe card is kept in contact with a pad of the chip. In order to slide the probe needle over a surface of the pad and thus to remove an aluminum oxide layer on the surface of the pad, a certain pressure is applied in between the probe needle and the pad in a state that the probe needle is in contact with the chip. Thus, an aluminum layer under the aluminum oxide layer and the probe needle are electrically connected to each other.

An example of the conventional probe card using such a probe needle is disclosed in U.S. Pat. No. 6,087,840, which is depicted in FIG. 1. The probe card of FIG. 1 includes a single layer printed circuit board 1. The probe needle 5 of the probe card is facilitated under the printed circuit board 1 in order for the probe needle 5 of tungsten to be radially arranged around an opening 3 of the printed circuit board 1. A contact portion for connecting a connector (not shown) provided at an end of the printed circuit board 1 is connected to roots of the probe needles 5 through printed wiring. Although the probe card of FIG. 1 can simultaneously measure 32 pads using the probe needles 5, the probe needles are manually mounted on the printed circuit board 1 by craftsmen, so that the pitches of chip pads can not shorten below 65 μm. Further, all chips of the wafer can not be subject to simultaneous test and the chips should be tested in several times, so that it takes long time and big cost to test the wafer.

Another example of the conventional probe card is disclosed in U.S. Pat. No. 6,114,864, which is depicted in FIG. 2. The probe card of FIG. 2 includes a substrate 21 that has a bottom surface in which a concave portion 22 is formed. An insulation resin film 23 is provided at the bottom surface of the substrate 21 and extended in order an inner end portion of the insulation resin film to be located under the concave portion 22. A conductive probe pattern 25 is formed on a bottom surface of the insulation resin film 23 to be reached the inner end portion. A solder ball 27 is formed on an inner end portion of the probe pattern 25 so that it is positioned in the concave portion 22. Wiring patterns 19 are electrically connected to the probe pattern 25 and formed on the top surface of the substrate 21. However, the probe card of FIG. 2 has a drawback in that it is susceptible to an external mechanical shock or temperature since a tip portion of the probe pattern 25 is formed with the solder ball 27.

Another example of the conventional probe card is disclosed in U.S. Pat. No. 6,059,982, which is depicted in FIG. 3. In a probe tip of the probe card of FIG. 3, a conductive line 41 is formed by patterning a metal layer, such as tungsten (W), copper (Cu), aluminum (Al), gold (Au) and so forth, deposited on a dielectric layer 31. A tip portion 42 of the conductive line 41 includes probe tip point 43. A stud 44 on an end 45 of the conductive line 41 is in electrical contact with a solder ball 51 through a transitional metal layer 49 in a via hole 48 of a silicon substrate 47. However, the probe card of FIG. 3 has a drawback in that mechanical properties are bad since a tip of the conductive line is made of tungsten, gold or aluminum instead of a metal needle type tip.

Another example of the conventional probe card is disclosed in U.S. Pat. No. 6,520,778, which is depicted in FIGS. 4a and 4b. The probe card of FIGS. 4a and 4b is formed by bonding a tip portion 61 in a shape of a metal wiring and a connection portion 71 of printed circuit board 70 on a sacrificial substrate 60, such as a silicon substrate, using a conductive adhesive 73, and then etching the sacrificial substrate 60. As shown in FIG. 4c, spring contact portions 90 and 92 are bonded on the connection portions 81 and 82 of the substrate 80, respectively. A post portion 91 of the spring contact portion 90 is bonded on the connection portion 81. One leading end of a bottom surface of a beam portion 95 is bonded on the post portion 91 with a spacer portion 93 interposed therebetween, and a tip portion 97 is bonded on the other leading end of an upper surface of the beam portion 95. A post portion 94 of the spring contact portion 92 is bonded on the connection portion 82. One leading end of a bottom surface of a beam portion 96 is bonded on the post portion 94, and a tip portion 99 is bonded on the other leading end of an upper surface of the beam portion 96 with a spacer portion 98 interposed therebetween. The probe card of FIGS. 4a, 4b and 4c has a drawback in that it is manufactured difficultly and production cost is high since the probe tip is formed by a bonding technology such as a soldering.

Another example of the conventional probe card is disclosed in U.S. Pat. No. 6,491,968, which is depicted in FIG. 5. In the probe card of FIG. 5, a post portion 111 of an interconnection portion 110 is bonded on a terminal 101 of a substrate 100. A body portion 112 of the interconnection portion is coupled to the post portion 111 and has a plurality of leaf portions 113. A tip portion 115 is bonded on a leading end of an upper surface of the leaf portion 113. The probe card of FIG. 5 has a structure for increasing elasticity using the leaf portions 113 so as to disperse a pressure applied to the probe tip of FIG. 4, but has a drawback in that it is difficult to manufacture the same.

Another example of the conventional probe card is disclosed in Korean Patent Publication No. 2000-27658, which is depicted in FIG. 6. As shown in FIG. 6, a probe 125 is arranged on an insulating substrate 121 in such a way that a tip portion of the probe 125 is positioned on a concave portion 123 of the insulating substrate 121. A metal portion 129 is arranged on a leading end of the tip portion. A wiring portion 127 is formed on the insulating substrate 121 and the probe 125. The probe is formed on a silicon substrate by wet-etching and the metal portion 129 is arranged on the leading end of the probe 125, so that it has drawback in that it has high resistance and it can be easily broken.

Another example of the conventional probe card is illustrated in FIG. 7. The probe card of FIG. 7 has a structure similar to that of the probe card of FIG. 4c, so that it has also the same drawback as that.

Thus, the probe cards of the prior art have the problems in that a separation of signals between the probe tip portions is difficult, in that mechanical properties are not good, in that a pad pitch of a semiconductor device is hardly reduced below 65 μm, and in that a flatness between the probe tip portions is hardly maintained within a few μm. As the result, it is impossible to test more than 32 simultaneous test, it is difficult to test chips in wafer level and it takes long test time and high cost.

### SUMMARY OF THE INVENTION

Accordingly, the present invention has been made to solve the above-mentioned problems occurring in the prior art, and an object of the present invention is to probe a semiconductor device with fine pad pitch.

Another object of the present invention is to probe chips in wafer level.

Another object of the present invention is to improve flatness of a probe tip.

Another object of the present invention is to improve mechanical and electrical properties of a probe tip.

Another object of the present invention is to reduce time and cost for probing.

In order to accomplish these objects, there is provided a microprobe for testing an electronic device, the microprobe including: a silicon substrate, whose one side is etched in a certain depth, having a via hole in another side; a conductive layer that filled the via hole; a cantilever type conductive spring unit electrically connected to the conductive layer, wherein one edge portion of the spring unit is supported only on the surface adjacent to the via hole and the other portion of the spring unit is spaced from the etched surface of the silicon substrate; and a conductive tip portion formed on the other edge portion of the spring unit.

Preferably, the spring unit is made of any one of copper, nickel, nickel-tungsten, nickel-chromium, tungsten and various kinds of plating alloys.

Preferably, the tip portion is made of any one of copper, nickel, nickel-tungsten, nickel-chromium, tungsten and various kinds of plating alloys.

Preferably, a seed layer is formed between the spring unit and the conductive layer in the same pattern as the spring unit, and the seed layer is made of any one of titanium/gold, titanium/copper, chromium/gold and chromium/copper.

According to another preferred embodiment of the present invention, there is provided a method of manufacturing a microprobe for testing an electronic device, the method including: forming a via hole in a portion of a silicon substrate; forming a first conductive layer in the via hole; after forming an opening on a portion of one surface of the silicon substrate, forming a seed layer on the exposed silicon substrate in the opening and the first conductive layer of the via hole; forming a pattern of the conductive spring unit on the seed layer as to overlap all the via hole and the opening; forming a conductive tip portion on a leading end of the spring unit; etching the seed layer that is not covered with the spring unit; and etching the silicon substrate under the spring unit.

Preferably, said forming the pattern of the spring unit includes: forming a pattern of a photoresist having a window overlapping all the via hole and the opening; and forming a pattern of a second conductive layer for the spring unit only in the window of the photoresist.

Preferably, the spring unit is formed by a plating method and is made of any one of copper, copper alloy, nickel, nickel-tungsten, nickel-chromium, nickel alloy, tungsten and various kinds of plating alloys.

Preferably, said forming the tip portion includes: forming a pattern of a photoresist having a window exposing a leading end of the spring unit on the spring unit and the seed layer; and forming a pattern of a third conductive layer for the tip portion only in the window of the photoresist.

Preferably, the tip portion is formed by a plating method and is made of any one of copper, copper alloy, nickel, nickel-tungsten, nickel-chromium, nickel alloy and tungsten.

Preferably, the silicon substrate under the spring unit is isotropically etched.

Preferably, the silicon substrate under the spring unit is isotropically wet-etched using any one of etching solutions including tetramethylammonium hydroxide (TMAH), KOH and ethyl diamine pyrocathechol (EDP).

Preferably, the silicon substrate under the spring unit is dry-etched by a reactive ion etching and an inductively coupled plasma etching.

Preferably, said forming the first conductive layer includes: putting the silicon substrate having the via hole into electrolyte for the first conductive layer; filling the via hole with the electrolyte by applying a certain pressure to the surface of the electrolyte; and leaving the first conductive layer only in the via hole by pulling out the silicon substrate from the electrolyte and polishing both surfaces of the silicon substrate.

Preferably, the electrolyte is any one of electrolyte including lead/tin and electrolyte including solder.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a probe card of the prior art using a cantilever type probe needle;

FIG. 2 illustrates a probe card of the prior art using a probe tip of solder ball;

FIG. 3 illustrates a probe card of the prior art using a probe tip of metal line;

FIGS. 4a and 4b illustrate a process showing a method of manufacturing a probe card of the prior art, and FIG. 4c illustrates a structure of the probe card of the prior art;

FIG. 5 illustrates a structure of the probe card of the prior art;

FIG. 6 illustrates another structure of the probe card of the prior art;

FIG. 7 illustrates another structure of the probe card of the prior art;

FIG. 8 illustrates a structure of a probe card using a microprobe for testing an electronic element according to the present invention;

FIGS. 9a to 9f illustrate processes showing a method of manufacturing a microprobe for testing an electronic element according to the present invention;

FIG. 10 is a photograph of Scanning Electron Microscope (SEM) showing a structure of a microprobe for testing electronic element;

FIGS. 11a to 11f illustrate a process of filling a via hole of a silicon substrate with a conductive layer according to a method of manufacturing a microprobe for testing an electronic element of the present invention; and

FIGS. 12a to 12d illustrate another process of filling a via hole of a silicon substrate with a conductive layer according to a method of manufacturing a microprobe for testing an electronic element of the present invention.

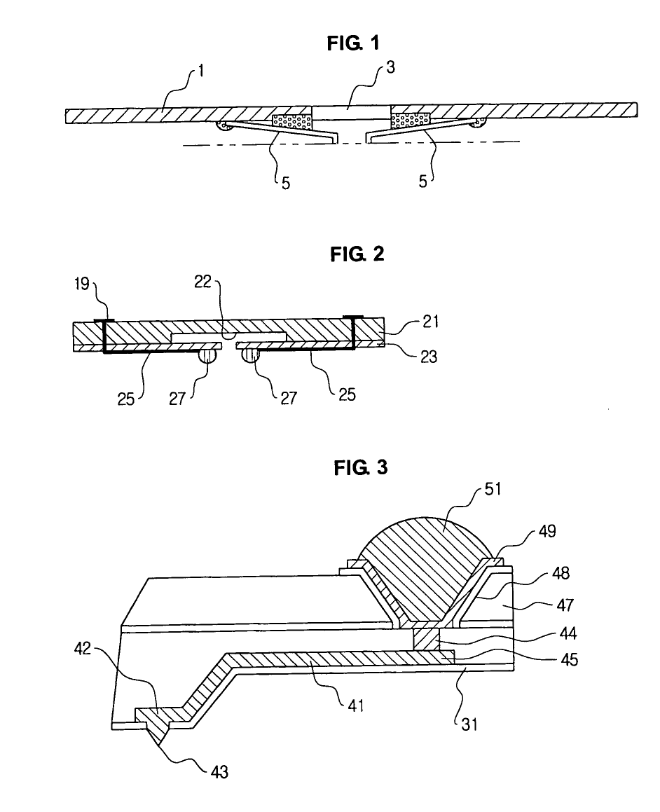

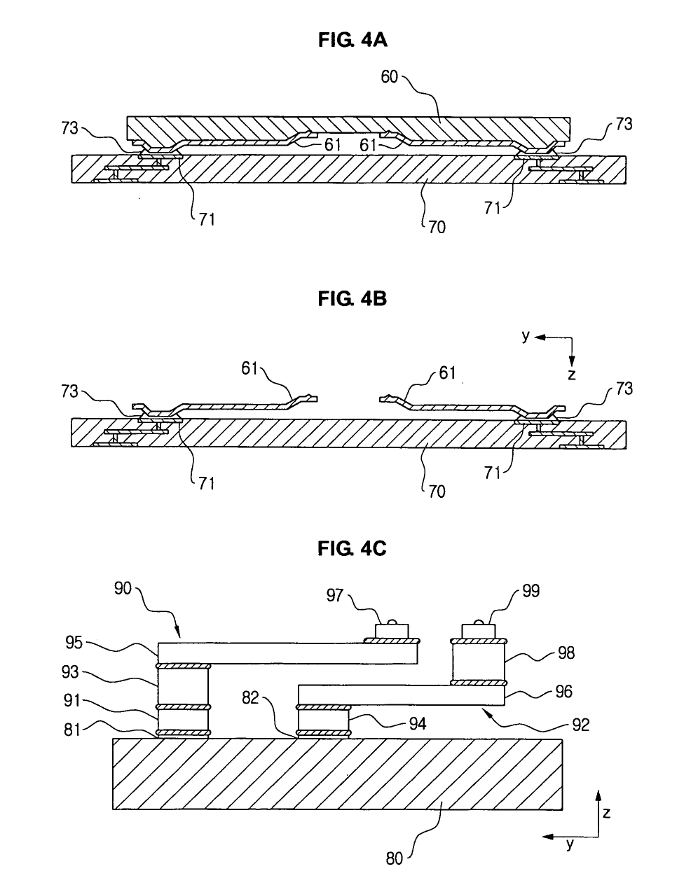

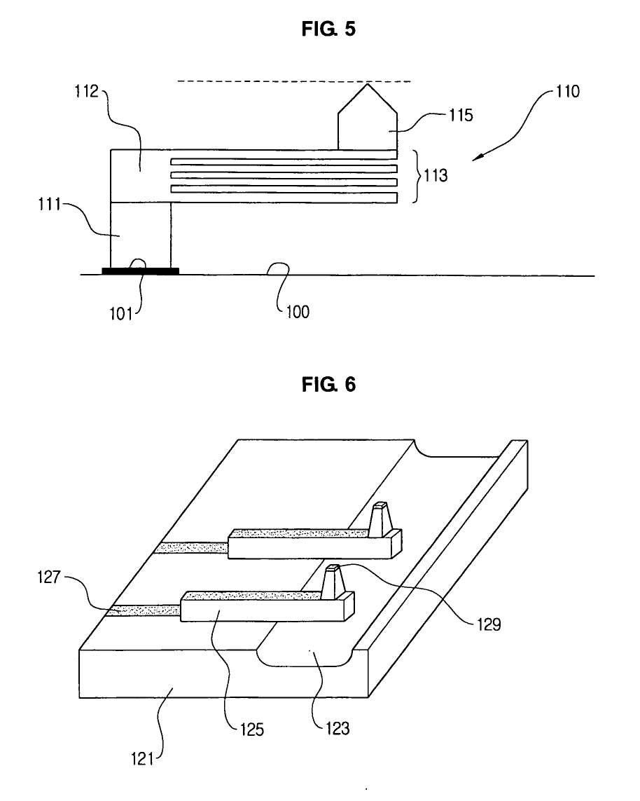

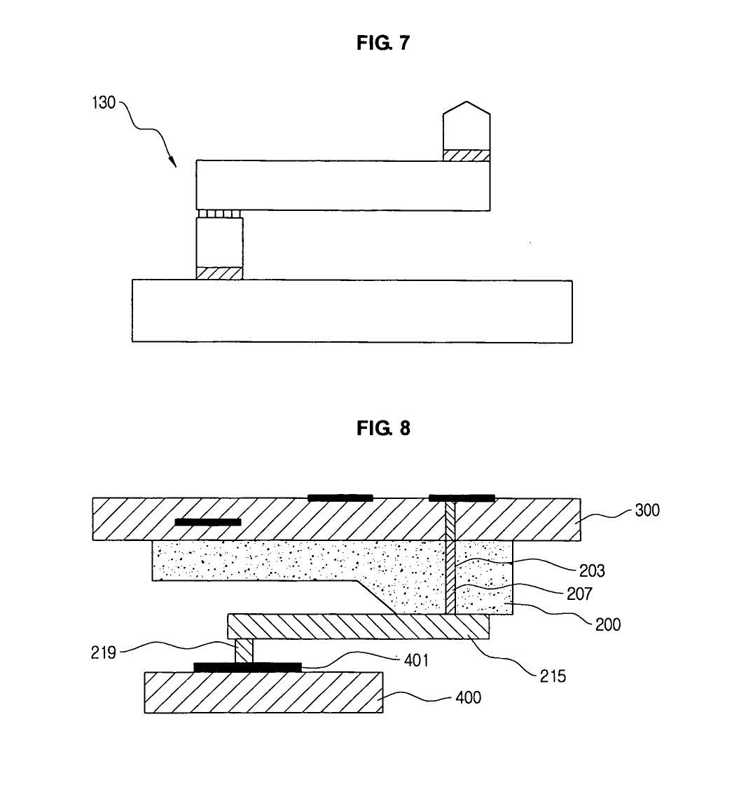

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description of the same or similar components will be omitted.

Referring to FIG. 8, a probe card using a microprobe of the present invention includes the microprobe and a printed circuit board 300. In the microprobe, a conductive layer 207 fills a via hole 203 formed on right edge portion of a single crystal silicon substrate 200. A conductive metal structured spring unit 215 is supported in a cantilever type on a bottom surface of right edge portion of the silicon substrate 200 and is electrically connected to the conductive layer 207. A conductive tip portion 219 to be in contact with a pad portion 401 of a wafer 400 is downwardly protruded from a leading end of the spring unit 215. An upper surface of the single crystal silicon substrate 200 is welded to a bottom surface of the printed circuit board 300 by a soldering, so that the conductive layer 207 of the single crystal silicon substrate 200 is electrically connected to a pad portion of the printed circuit board 300. FIG. 8 illustrates that only one spring unit 215 is formed on the silicon substrate 200 for convenience in explaining the present invention, however, it is clear that a plurality of spring units corresponding to the number of pad portions of a wafer to be tested can be arranged on the silicon substrate 200.

A Silicon-On-Insulator (SOI) substrate, a Spin-On-Glass (SOG) substrate and a substrate manufactured by direct or indirect bonding process can be preferably used, instead of the silicon substrate 200.

Also, the conductive layer 207 can be made of a copper layer or a nickel layer and can be electrically insulated from the silicon substrate 200 by an insulating layer (not shown) formed in an inner wall of the via hole. The insulating layer can be any one of a thermal oxide layer, a tetraethylorthosilane (TEOS) chemical vapor deposition (CVD) oxide layer, or a nitride layer.

Also, the spring unit 215 and the tip portion 219 can be made of any one of copper, nickel, nickel-tungsten (Ni-W), nickel-chromium (Ni-Cr), tungsten (W) or various kinds of alloys of copper or nickel.

The probe card of the present invention having the above construction has benefits in that mechanical and electrical properties of the probe tip are good and a separation of signal between tip portions is easy because the probe is formed on the single crystal silicon substrate by micro-processing. Also, since the pitch between the tip portions can be reduced, a semiconductor device with fine pitch pad can be tested. Furthermore, the flatness of the probe tip can be improved as to be maintained within a few μm.

Meanwhile, since a force of 100 mN is applied to a test device and a wafer to be tested using the probe card, when signal from the test device (not shown) is inputted to a semiconductor device of the wafer and result signal outputted from the semiconductor device is transferred to the test device, it is preferable that the probe of the present invention can endure such force of about 100 mN. Further, it is preferable that the probe of the present invention has reliability that can secure more than one million probing through a contact with the wafer. Furthermore, it is preferable that contact resistance of the probe tip is below 1 Ω.

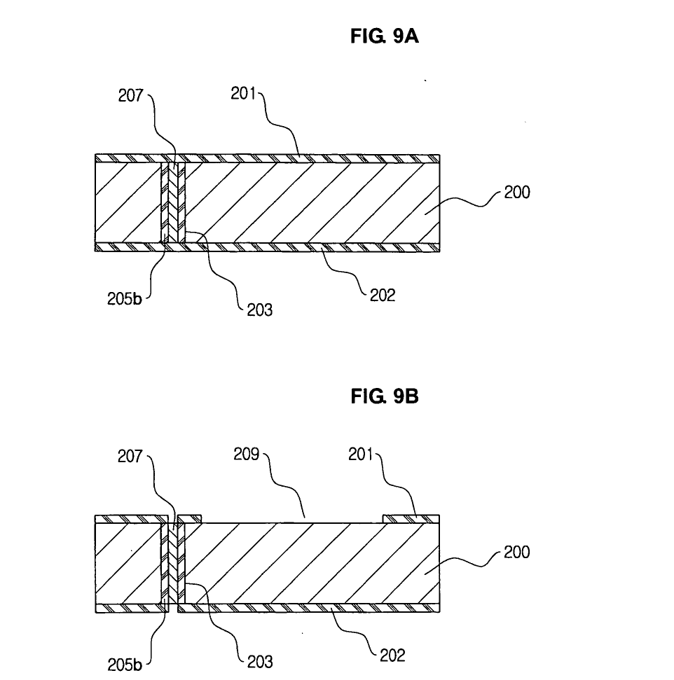

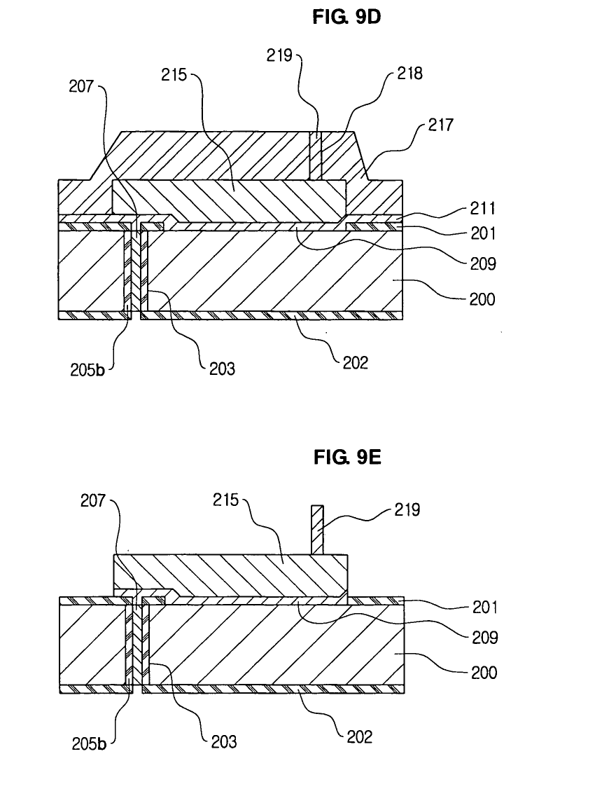

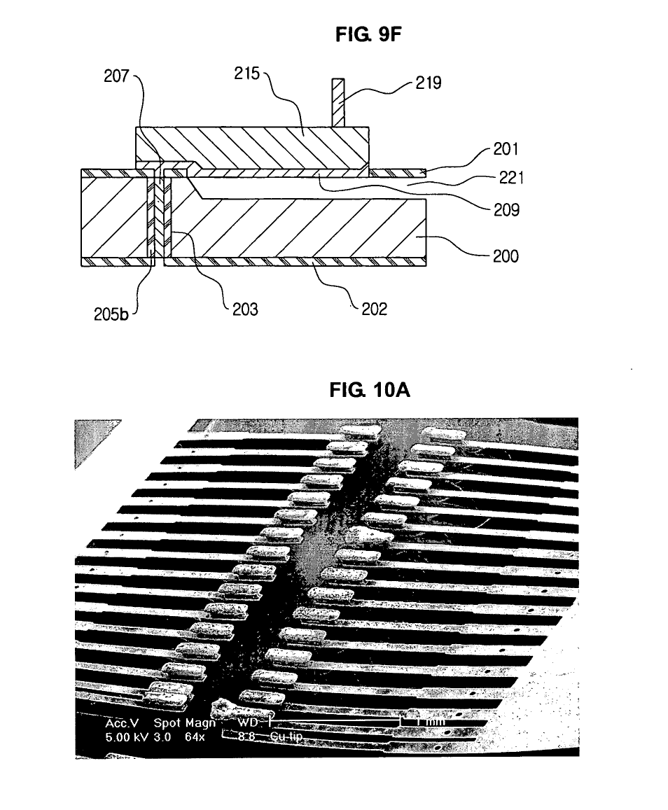

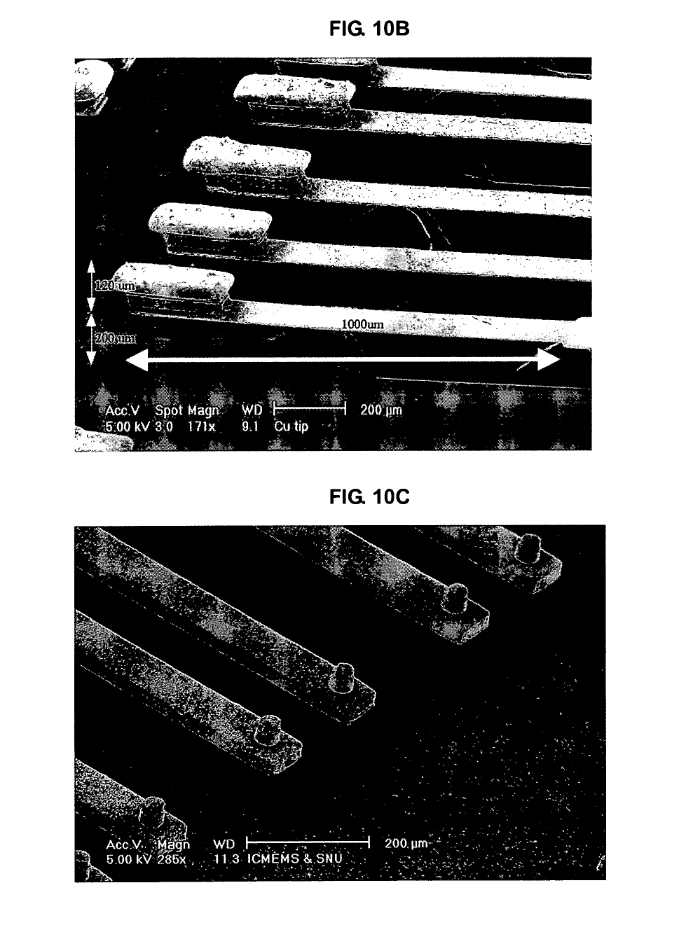

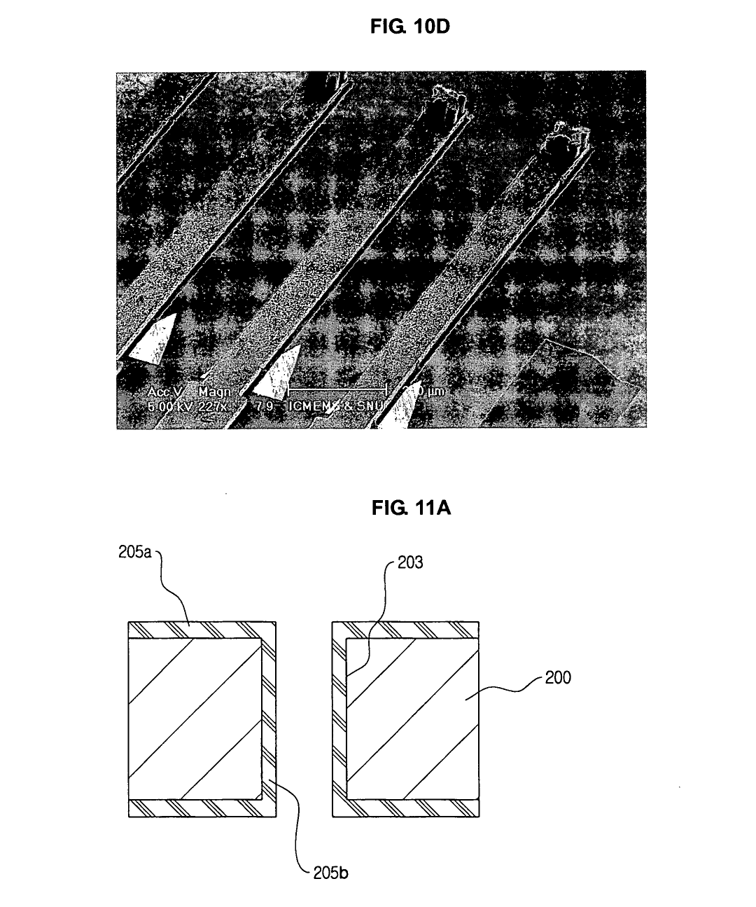

A manufacturing method of the microprobe for testing an electronic device according to the present invention will now be described with reference to FIGS. 9a to 9f and FIG. 10.

The present invention will be described hereinafter with reference to FIG. 9a.

First, a semiconductor substrate such as a single crystal substrate 200 is provided. At this time, an SOI substrate, an SOG substrate and a substrate manufactured by direct or indirect bonding process can be preferably used, instead of the silicon substrate 200.

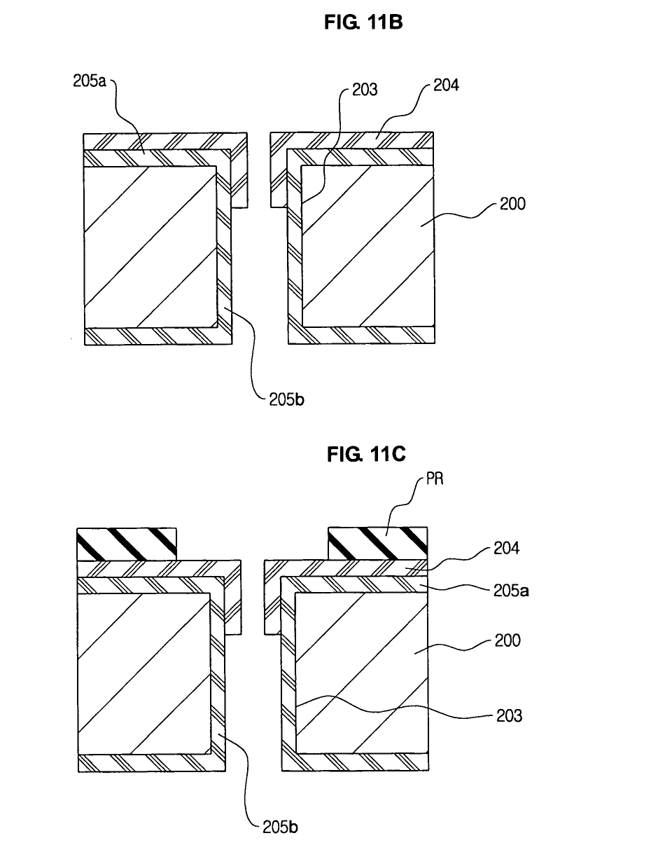

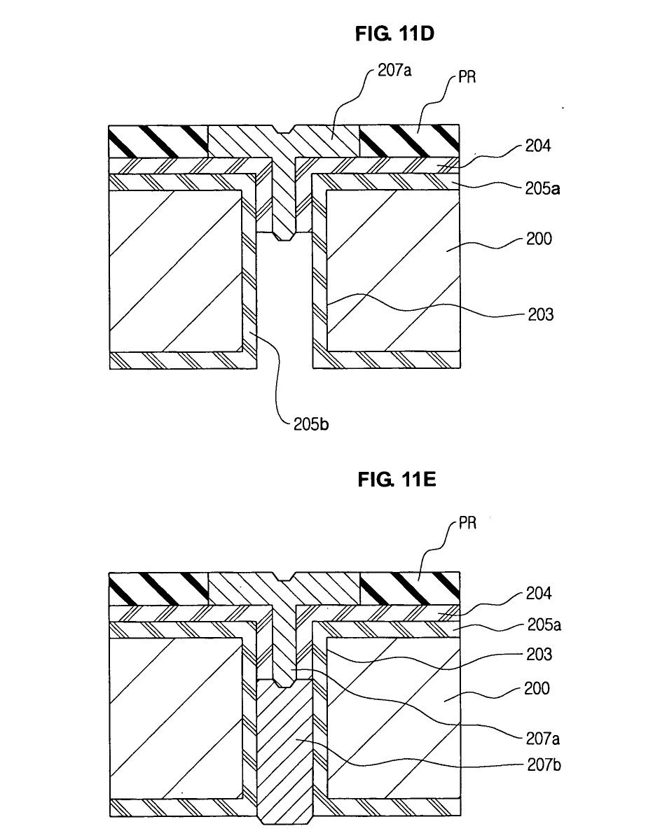

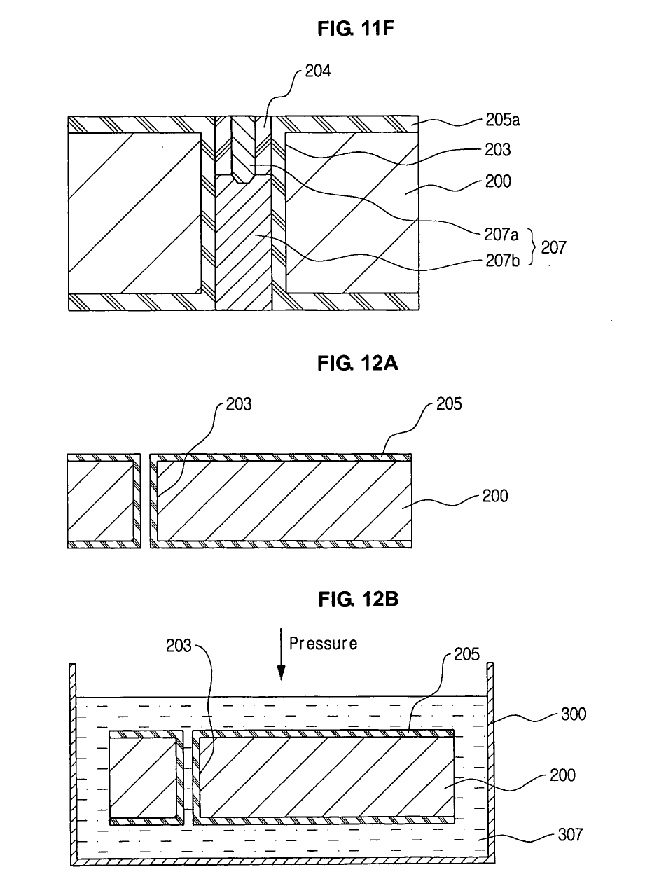

Then, a via hole 203 vertically extending through the silicon substrate 200 is formed over a desired region of the silicon substrate 200. A conductive layer 207 is formed only in the via hole 203. Hereinafter, a process for forming the conductive layer 207 will be described in more detail with reference to FIGS. 11a to 11f. As shown in FIG. 11a, the via hole 203 is formed over the desired region of the silicon substrate 200 using a general process. As an etching process for forming the via hole 203, an anisotropic dry-etching is preferably used. Preferably, a diameter of the via hole 203 is below 100 μm and a depth thereof ranges between 200 to 1000 μm. Then, a first insulating layer 205a is formed on an upper and lower sides of the silicon substrate 200 and a second insulating layer 205b is formed on an inner wall of the via hole 203. At this time, the second insulating layer 205b is preferably formed in such a depth as required to electrically insulate the conductive layer 207 that filled the via hole 203 from the silicon substrate 200. The second insulating layer 205b can be a thermal oxide layer, a TEOS oxide layer or a nitride layer.

Then, as shown in FIG. 11b, a seed layer 204 is formed on one side of the silicon substrate 200, for example, on the first insulating layer 205a of the upper side of the silicon substrate 200. The seed layer 204 is also formed on the second insulating layer 205b in the via hole 203 adjacent to the upper side. The seed layer 204 can be made of any one of titanium-gold, titanium-copper, chromium-gold and chromium-copper. The seed layer 204 can be also formed of tungsten or copper using CVD.

Then, as shown in FIG. 11c, a pattern of photoresist PR as a mask for electroplating is formed on a portion of the seed layer 204, that is, a portion where an electroplating should not be performed, using a general photolithography. Then, as shown in FIG. 11d, a first conductive layer 207a, for example, copper layer or nickel layer, is formed on the exposed portion of the seed layer 204 using the electroplating method, in a state that the upper side of the silicon substrate 200 is in contact with electrolyte of an electroplating apparatus (not shown), that is, electrolyte for electroplating of the first conductive layer 207a. At this time, since the seed layer 204 is formed in a portion of the via hole 203, the first conductive layer 207a is also formed on the seed layer 204 in the via hole 203.

Then, as shown in FIG. 11e, a second conductive layer 207b is formed on the first conductive layer 207a in the via hole 203, in a state that the lower side of the silicon substrate 200 is in contact with electrolyte of an electroplating apparatus (not shown), that is, electrolyte for electroplating of the second conductive layer 207b. At this time, the second conductive layer 207b is not formed, since the seed layer is not formed on the lower side of the silicon substrate 200 at an outer side of via hole 203.

Finally, as shown in FIG. 11f, after the PR is removed, the conductive layers 207a, 207b have the same height as the insulating layers 205 on the upper and lower sides of the silicon substrate 200 by polishing the upper and lower sides of the silicon substrate 200 using, for example, chemical mechanical polishing (CMP). At this time, the conductive layers 207a and 207b remains not at the outer portion of the via hole 203 but in the via hole 203. The conductive layers 207a, 207b can completely fill only the via hole 203.

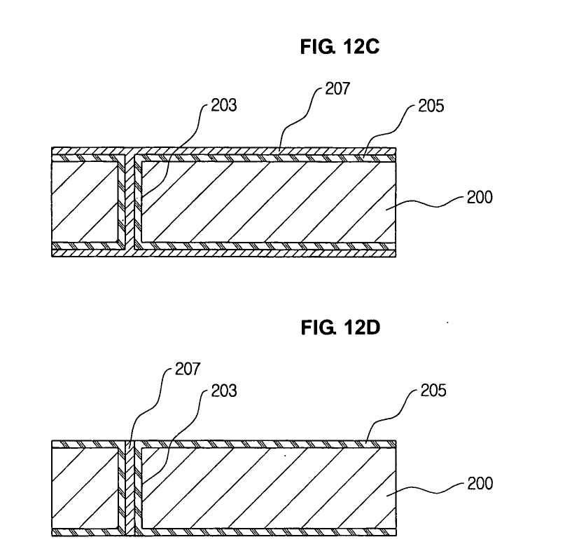

As shown in FIGS. 12a to 12d, the via hole 203 is formed on a portion of the silicon substrate 200 and the insulating layers 205 are formed on the upper and lower sides of the silicon substrate 200 and the inner wall of the via hole 203, by performing the same process as one illustrated in FIG. 11a. Then, after the silicon substrate 200 is completely put into electrolyte 307, such as lead/tin or solder, electrolyte for the conductive layers 207, in a chamber 300, a certain pressure is applied to the surface of electrolyte. At this time, the via hole 203 is filled with the electrolyte 307 by capillary phenomenon, thereby forming the conductive layer 207. The conductive layer 207 is also formed on the insulating layers 205 on the upper and lower sides of the silicon substrate 200. Finally, the conductive layers 207 on the upper and lower sides of the silicon substrate 200 are polished by, for example, CMP. Accordingly, the conductive layer 207 in the via hole 203 remains but the conductive layer 207 at the outer portion of the via hole 203 is removed. As a result, the via hole 203 is filled with the conductive layer 207.

On the other hand, upon using an electro-less plating instead of electroplating, the conductive layer 207 (for example, one of the copper layer or nickel layer) is directly formed on the insulating layer 205 without forming the seed layer, so that it is possible to fill the via hole 203 with any one of the copper layer and the nickel layer. It is also possible to fill the via hole 203 with a tungsten layer and a gold layer additionally, by depositing a poly crystal silicon layer directly on the insulating layer 205 without forming the seed layer and depositing the tungsten layer thereon by CVD.

Once the conductive layer 207 is formed only in the via hole 203 using such various methods, a third insulating layer 201 and a fourth insulating layer 202 made of the same material are formed on the upper and lower sides of the silicon substrate 200. An oxide layer or a nitride layer can be the insulating layers 201 and 202. Oxide layers for the third insulating layer 201 and the fourth insulating layer 202 can be formed on both sides of the silicon substrate 200 by an oxidation process such as an oxidation process in an reaction chamber (not shown), or oxide layers for the third insulating layer 201 and the fourth insulating layer 202 can be formed on both sides of the silicon substrate 200 by plasma CVD. At this time, TEOS can be injected into the reaction chamber (not shown) so as to grow the oxide layers at a temperature of 400° C.

Referring to FIG. 9b, after the third insulating layer 201 and the fourth insulating layer 202 have been formed, an opening 209 for exposing the area for the via hole 203 and the spring unit 215 of FIG. 9f is formed on a portion of the third insulating layer 201 on upper side of the silicon substrate 200, using a general photolithography.

Referring to FIG. 9c, after the opening 209 has been formed, a seed layer 211, which can be made of titanium-gold, titanium-copper, chromium-gold or chromium-copper, is deposited on the exposed portion of the silicon substrate 200, the conductive layer 207 and the third insulating layer 201. Accordingly, the seed layer 211 is electrically connected to the conductive layer 207 in the via hole 203 and the exposed portion of the silicon substrate 200.

Then, after a PR 213 is coated on the seed layer 211 with thick thickness, the PR 213 is patterned in order to have a window corresponding to a pattern of the spring unit. The window is located on both the via hole 203 and the opening 209, and the thickness of the PR 213 determines that of the spring unit 215.

Then, a third conductive layer for the spring unit 215, which can be made of copper, nickel, nickel-tungsten, nickel-chromium, tungsten or various plating alloy, is formed on the exposed seed layer 211 in the window by a plating method. Accordingly, the seed layer 211 is electrically connected to the spring unit 215.

At this time, the thickness of the spring unit 215 can be determined by the thickness of the PR 213. Of course, the third conductive layer can be formed by CVD or sputtering.

Referring to FIG. 9d, after the spring unit 215 is formed, the PR 213 of FIG. 9c is completely removed. Then, after a PR 217 is coated on the spring unit 215 and the seed layer 211, the PR 217 is patterned so that a window 218 for forming a tip portion 219 exposes a partial region adjacent to the leading portion of the spring unit 215. At this time, the thickness of the PR 217 is determined in consideration of the thickness of the spring unit 215.

Then, a fourth conductive layer for the tip portion 219, for example, a conductive layer with the same material as the spring unit 215, is formed on the exposed spring unit 215 in the window 218 by a plating method. Accordingly, the tip portion 219 is electrically connected to the spring unit 215. On the other hand, a height of the tip portion 219 can be determined by the thickness of the PR 217.

Referring to FIG. 9e, after the tip portion 219 is formed, the PR 217 of FIG. 9d is removed and the seed layer 211, which is not covered with the spring unit 215, is etched by using the spring unit 215 as an etching mask. Accordingly, only the seed layer 211 under the spring unit 215 remains in the same pattern as the spring unit 215.

Referring to FIG. 9f, after removing the seed layer 211, which is not covered with the spring unit 215, the silicon substrate 200 not covered with the spring unit 215 and the third insulating unit 201 is etched isotropically. At this time, the silicon substrate 200 under the spring unit 215 is also etched so that an empty space 221 under the spring unit 215 is formed and only edge portion of the spring unit 215 adjacent to the via hole 203 is supported by the silicon substrate 200. Thus, the spring unit 215 has a shape of a cantilever. The shape of the spring unit 215 provides the spring unit 215 and the tip portion 219 with proper elasticity so that the spring unit 215 and the tip portion 219 can endure a force of about 100 mN or more applied upon testing the semiconductor device.

On the other hand, for etching the silicon substrate, a wet etching using any one of etching solutions including tetramethylammoniun hydroxide (TMAH), KOH and ethyl diamine pyrocathechol (EDP), or a dry-etching such as a reactive ion etching (RIE) or an inductively coupled plasma (ICP) etching is preferably used.

For convenience in explanation of the present invention, only one spring unit 215 is illustrated in the drawing to be formed on the silicon substrate 200. However, it is clear that a plurality of spring units corresponding to the number of pad portions of the wafer to be tested can be arranged. The microprobe manufactured by such method has a solid structure as shown in the photographs by SEM of FIGS. 10a to 10d.

Finally, as shown in FIG. 8, the microprobe is bonded on printed circuit board 300 by soldering and is covered by resin (not shown) such as epoxy resin so as to be protected from external environment or mechanical shock.

Accordingly, as shown in FIG. 8, when the tip portion 219 of the spring unit 215 brings into contact with the pad portion 401 of the wafer 400 to be tested, the pad portion 401 is electrically connected to the tip portion 219, the spring unit 215, the conductive layer 207 and the connection portion of printed circuit board 300. Thus, chips of the wafer 400 can be tested using a test device (not shown) that is electrically connected to the printed circuit board 300.

The microprobe of the present invention is manufactured by using a silicon substrate as a substrate and an oxide layer or a nitride layer as an insulating layer, and by micro-processing the substrate. Thus, the microprobe of the present invention has benefits in that a separation of signal between tip portions is easy and mechanical and electrical properties of the probe tip are good. Also, the microprobe can be designed to endure a force of about 100 mN or more. Since the pitch between the tip portions can be reduced so that a distance between pad portions of the semiconductor device can be also reduced. Further, it is possible to test a semiconductor device with fine pitch pad. Furthermore, it is possible to maintain the flatness of the probe tip within a few μm.

Accordingly, the present invention can perform more than 32 simultaneous measurement test, which is a limit to a probe card of the prior art, and a test of wafer level, which reduces testing time and cost.

In order to make a electrode wiring with an active chip including a circuit easy, the present invention can perform a wiring process on a back surface of a probe wafer through a masking process and bond the probe chip and the active chip by a flip-chip bonding.

As described above, the microprobe of the present invention is manufactured by forming via hole on one edge portion of the silicon substrate, filling the via hole with the conductive layer, forming the conductive spring unit on the silicon substrate so as to be electrically connected to the conductive layer in the via hole, forming the conductive tip portion on the leading end of the spring unit and removing the silicon substrate under the spring unit using isotropic etching, thereby supporting the spring unit only on the portion adjacent to the via hole. The spring unit and the tip portion are formed only in the window of the PR.

Accordingly, the microprobe of the present invention has benefits in that a separation of signal between tip portions is easy and mechanical and electrical properties of the probe tip are good since the probe is formed on the silicon substrate by using micro-processing technology. Also, since the pitch between the tip portions can be reduced, a semiconductor device with fine pitch pad can be tested. Furthermore, the uniformity of flatness of the probe tip portion can be improved.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A microprobe for testing an electronic device comprising:
a silicon substrate having an etched side and a second side being opposite said etched side, said etched side being etched a certain depth, said second side having a hole;
a conductive layer filling said hole;
a cantilever conductive spring unit electrically connected to said conductive layer, wherein said cantilever conductive spring unit having a first edge portion that is supported on a surface adjacent to said hole and a remainder of said cantilever conductive spring unit is spaced from said etched side; and
a conductive tip portion formed on a second edge portion of said cantilever conductive spring unit.

2. The microprobe of claim 1, wherein said cantilever conductive spring unit is made of a material being selected from the group consisting of copper, nickel, nickel-tungsten, nickel-chromium, tungsten, a plating alloy, and any combinations thereof.

3. The microprobe of claim 1, wherein said conductive tip portion is made of a material being selected from the group consisting of copper, nickel, nickel-tungsten, nickel-chromium, tungsten, a plating alloy, and any combinations thereof.

4. The microprobe of claim 1, further comprising a seed layer formed between said cantilever conductive spring unit and said conductive layer, said seed layer being electrically connected to said conductive layer, wherein said seed layer has a first edge portion that is supported on a surface adjacent to said hole and a remainder of said seed unit is spaced from said etched side.

5. The microprobe of claim 4, wherein said seed layer is made of a material being selected from the group consisting of titanium-gold, titanium-copper, chromium-gold, and chromium-copper, and any combinations thereof.

6. A method of manufacturing a microprobe for testing an electronic device, comprising the steps of:
forming a hole in a portion of a silicon substrate;
forming a first conductive layer in said hole;
forming an opening on a portion of a surface of said silicon substrate;
forming a seed layer on an exposed portion of said silicon substrate in said opening and said first conductive layer of said hole;
forming a pattern of a conductive spring unit on said seed layer overlapping said hole and said opening;
forming a conductive tip portion on a leading end of said conductive spring unit;
etching said seed layer that is not covered with said conductive spring unit; and
etching said silicon substrate under said conductive spring unit.

7. The method of claim 6, wherein the step of forming said pattern of said conductive spring unit comprises:
forming a first pattern of a photoresist having a window overlapping all of said hole and said opening; and
forming a second pattern of a second conductive layer for said conductive spring unit, said second pattern being only in said window.

8. The method of claim 7, wherein said conductive spring unit is formed by a plating method.

9. The method of claim 8, wherein said conductive spring unit is made from a material being selected from the group consisting of copper, nickel, nickel-tungsten, nickel-chromium, tungsten a plating alloy, and any combinations thereof.

10. The method of claim 6, wherein the step of forming said conductive tip portion comprises:
forming a pattern of a photoresist having a window exposing a leading end of said conductive spring unit, said pattern being on said conductive spring unit and said seed layer; and
forming a second pattern of a second conductive layer for said conductive tip portion only in said window of said photoresist.

11. The method of claim 10, wherein said conductive tip portion is formed by a plating method.

12. The method of claim 11, wherein said conductive tip portion is made of a material being selected from the group consisting of copper, nickel, nickel-tungsten, nickel-chromium, tungsten, a plating alloy, and any combinations thereof.

13. The method of claim 6, wherein said silicon substrate under said conductive spring unit is isotropically etched.

14. The method of claim 13, wherein said silicon substrate is isotropically wet-etched using an etching solution being selected from the group consisting of tetramethylammonium hydroxide (TMAH), KOH, ethyl diamine pyrocathechol (EDP), and any combinations thereof.

15. The method of claim 13, wherein said silicon substrate is dry-etched by a reactive ion etching and an inductively-coupled plasma etching.

16. The method of claim 6, wherein the step of forming the first conductive layer comprises:
putting said silicon substrate having said hole into an electrolyte for said first conductive layer;
filling said hole with said electrolyte by applying a desired amount of pressure to a surface of said electrolyte; and
leaving said first conductive layer only in the said hole by pulling out said silicon substrate from said electrolyte and polishing said silicon substrate.

17. The method of claim 16, wherein said electrolyte is selected from the group consisting of an electrolyte having lead, an electrolyte having tin, an electrolyte with solder, and any combinations thereof.
